(19) United States
(12) Patent Application Publication
(10) Pub. No.: US 2005/0102425 A1
(43) Pub. Date: May 12, 2005

(54) Method of handing over a terminal

(76) Inventor: Martin Henry Kitchen, Klarup (GB)

Correspondence Address: POTOMAC PATENT GROUP PLLC, P. O. BOX 855, MCLEAN, VA, 22101, US

(21) Appl. No.: 10/496,291

(22) PCT Filed: Oct. 30, 2002
(86) PCT No.: PCT/EP02/12083

(30) Foreign Application Priority Data
Nov. 22, 2001 (EP) 01610121.4
Nov. 23, 2001 (US) 60332047

(51) Int. Cl. G06F 15/173

(52) U.S. Cl. 709/243; 370/331; 455/440

(57) ABSTRACT

This invention comprises the handing over of a mobile terminal when connected to one of a plurality of network access points with a view to data communication. According to the invention a subroup of said network access points is defined and others of the network access points are excluded from paging the terminal. The subgroup is defined on the basis of further communication between the terminal and the current network access point which is in contact with the terminal immediately before the handing over of the data communication.

This application is a national stage application of PCT International Application No. PCT/EP02/12083, which claims priority to a) European Patent Application No. 01610121.4 filed 22 Nov. 2001 in the European Patent Office, and b) U.S. Provisional Application No. 60/332,047 filed in the U.S. Patent and Trademark Office on 23 Nov. 2001.

### BACKGROUND OF THE INVENTION

The invention relates to a method for handing over a terminal preferably an access network user (ANU) from a network access point (NAP) to another NAP, said NAPs being part of an access network (AN).

In short range radio communication, a plurality of network access points may be arranged in a building so that access network users, which may e.g. be mobile telephones, are in radio communication contact with one network access point at a time. When the user moves about in the building, it is necessary that the radio contact switches between a plurality of access points, and this process is called handing over in the art.

Another special term within this technical field is paging, which means that a network access point communicates with an access network user in accordance with a predetermined protocol or standard for signal exchange. Typically, NAP transmits a PAGE signal, while AND scans for the PAGE signals. The invention is useful in connection with any communications standard, a preferred example in connection with the invention being the Bluetooth communications standard.

The paging process itself takes some time, and the data communication typically going on between a network access point and a plurality of other access network users will be interrupted, while the network access point pages a new access network user. Another problem is that the frequencies used for said communication are close to each other, thereby involving a risk of interference and thus errors.

### SUMMARY OF THE INVENTION

An exemplary method for handing over a terminal, for example an access network user (ANU), from a network access point (NAP) to another NAP, wherein said NAPs are part of an access network (PAN), and wherein a number of NAPs is initiated to page said terminal to be handed over with a view to continuing a data communication, includes identifying a subgroup of said NAPs and excluding NAPs not belonging to said subgroup from paging said terminal, wherein said identification is based on further communication exclusively between said terminal and the current network access point which is in contact with the terminal immediately before initiation of handing over of the data communication to another network access point.

### BRIEF DESCRIPTION OF THE DRAWING FIGURES

Exemplary embodiments of the invention will be explained more fully by the following description with references to the drawings, wherein:

FIG. 1 schematically illustrates a field of use of the invention.

FIGS. 2-3 show a first example and a second example, respectively, of the determination of the position of the ANU relative to the NAPs.

FIGS. 4-5 show examples of how a subgroup is identified on the basis of the determination of the ANU relative to the NAPs.

FIG. 6 shows a further embodiment of the invention.

### DETAILED DESCRIPTION OF THE INVENTION

Exemplary embodiments of the invention relate to a method for handing over a terminal preferably an access network user (ANU) from a network access point (NAP) to another NAP, said NAPs being part of an access network (AN), and wherein a number of NAPs is initiated to page said terminal to be handed over with a view to continuing a data communication.

Exemplary embodiments of the invention are particularly useful for short range radio communication, where e.g. a plurality of network access points may be arranged in a building so that access network users, which may e.g. be mobile telephones, are in radio communication contact with one network access point at a time, and this should preferably be the access point from where the most effective and faultless data communication with the mobile telephone may be established. When the user moves about in the building, it is necessary that the radio contact switches between a plurality of access points, and this process is called handing over in the art.

Another special term within this technical field is paging, which means that a network access point communicates with an access network user in accordance with a predetermined protocol or standard for signal exchange. Typically, NAP transmits a PAGE signal, while AND scans for the PAGE signals. The invention is useful in connection with any communications standard, a preferred example in connection with the invention being the Bluetooth communications standard.

The paging process itself takes some time, and the data communication typically going on between a network access point and a plurality of other access network users will be interrupted, while the network access point pages a new access network user. Another problem is that the frequencies used for said communication are close to each other, thereby involving a risk of interference and thus errors.

An object of the invention is to reduce the density of signals in connection with an access network to page the access network users so as to achieve fewer drop-outs of data communications.

This can be achieved in accordance with exemplary embodiments of the invention in that only a subgroup of network access points is initiated to page the terminal, while other network access points are excluded from paging the terminal. This reduces the density of signals, and thereby interference and signal drop-out are reduced.

It will be appreciated that the fewer network access points contained in said subgroup, the more the density of signals due to paging can be reduced. The invention is based on the finding that a considerable reduction in the density of signals may be achieved by a further communication exclusively between said terminal and the current network access point which is in contact with the terminal immediately before the data communication is handed over to another network access point.

Preferably, the further communication only comprises a rough determination, which, in a preferred embodiment, can typically exclude half of the NAPs from paging the terminal. The determination typically comprises determination of the position of the terminal relative to the current network access point which has exchanged data with the terminal immediately before the handing-over process of the data communication is initiated. The rough determination may also comprise other parameters, such as a determination of the direction of movement of the terminal relative to the current network access point.

In practice, it will frequently be so that the terminal is either present at a location where the rough determination relative to the current network access point is relatively reliable, or at a location where this rough determination is relatively unreliable. In a preferred embodiment, the subgroup is defined as the network access points which are positioned within a relatively unreliable range for the rough determination. In another preferred embodiment, the subgroup may be defined as either the one or the other set of network access points where the rough determination is relatively reliable, but in any event combined with the network access points where the location determination is relatively unreliable.

The further communication may comprise measurement of signal phase difference. The identification of a subgroup may also be determined on the basis of a specific antenna radiation pattern. In an embodiment, several, e.g. the two last-mentioned measuring methods may be combined to achieve a final subgroup, which is defined on the basis of the determination and two or more subgroups according to the above-mentioned principles.

An overall server may be provided with information about where the network access points are positioned relative to each other, and this information will typically be comprised in a table in an AN server. The server may be dynamically updated.

In big LAN systems with many NAPs a group of NAPs in the vicinity of the current NAP is first defined in a preferred embodiment. Thereafter the one or more subgroups are defined as explained above in relation to the current NAP. Thereby it is possible, when using very limited communication for defining said subgroups, to reduce the density of signals substantially, especially in big LANs, thereby reducing the risk of interference and dropouts of the data communication.

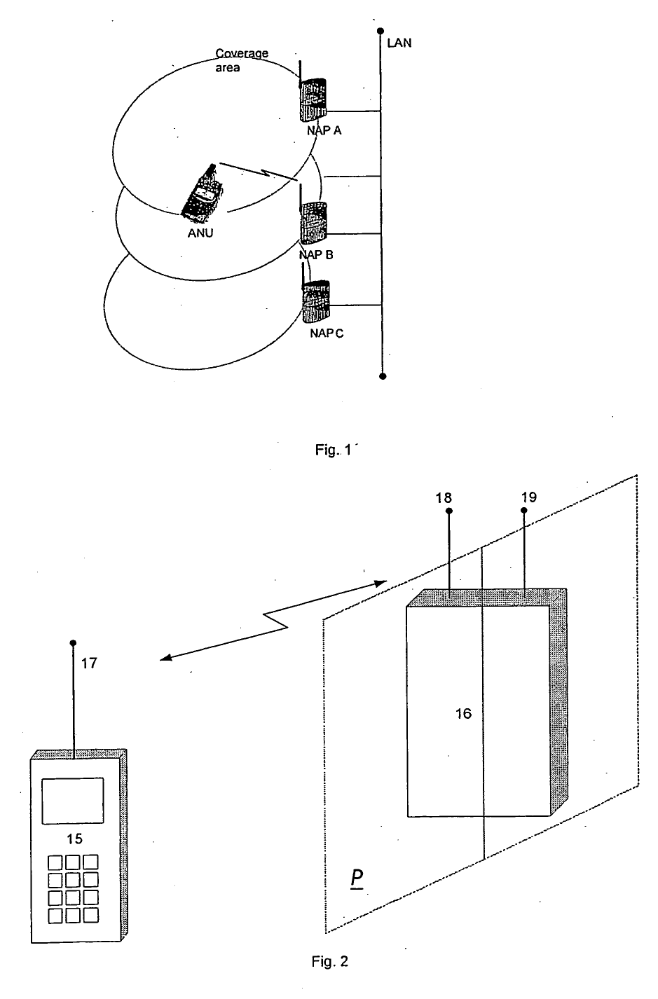

FIG. 1 shows an example of the use of the invention where the access network user (ANU) is shown by a mobile telephone which may be in radio contact for the communication of data with one of a number of network access points NAPA, NAPB or NAPC, which are connected to a local area network (LAN). In a preferred embodiment, radio communication takes place in accordance with the Bluetooth communications standard which defines how an NAP is to page a ANU.

The entire process is initiated in that an existing data connection between ANU and NAPB becomes too poor, i.e. so poor that it is very likely that a better connection may be achieved between ANU and one of the other NAPs. This evaluation may be based on a signal strength measurement or a measurement of rates of bit error or optionally a measurement of how many data packages are lost in the communication. It is stressed that the measuring method or other indications of the link quality initiating the handover procedure are not within the scope of the invention. The invention concerns optimizing the actual paging process when it is observed that the connection between a ANU and e.g. NAPB is too poor.

In the prior art, both NAPA and NAPC as well as other NAPs connected to LAN will successively try to make contact with ANU. While NAPA pages ANU, the data communication going on between NAPA and other ANUs will be interrupted temporarily, which involves a certain risk that the communications connection to one or more of the other ANUs will be lost. Furthermore, there is a great risk that the signals interfere with other signals so that the data communication between the other NAPs and respective ANUs may also be interrupted. According to the invention, it is ensured that NAPC does not page ANU at all, thereby substantially reducing the density of signals and the risk of interference.

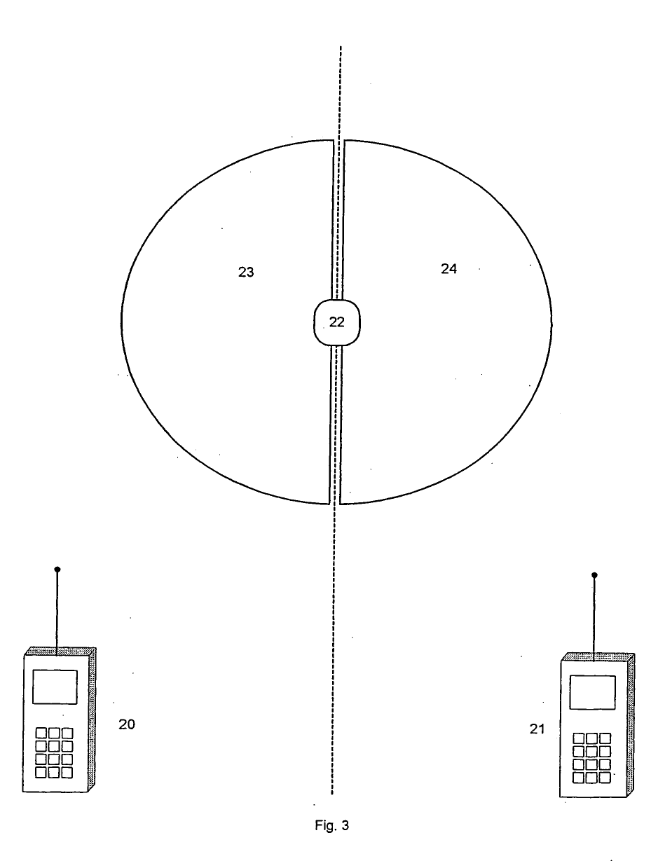

FIG. 2 schematically shows how it may be detected whether an ANU 15 is present at one or the other side of the plane P. shown in dotted line, through a NAP 16. ANU 15 has an antenna 17 which communicates with two antennas 18 and 19 on NAP 16, and based on a phase difference measurement it is possible to determine the position of ANU 15 relative to NAP 16. It can also be determined by means of Doppler effect whether ANU moves toward or away from NAP 16, which may be used as a supplement for the definition of a subgroup.

FIG. 3 schematically illustrates a NAP 22, which is equipped with at least two directional antennas e.g. having the radiation diagrams which are shown at 23 and 24. It may be determined in this manner whether PANU 20 and 21 is present on one or the other side of the dashed line shown in FIG. 3.

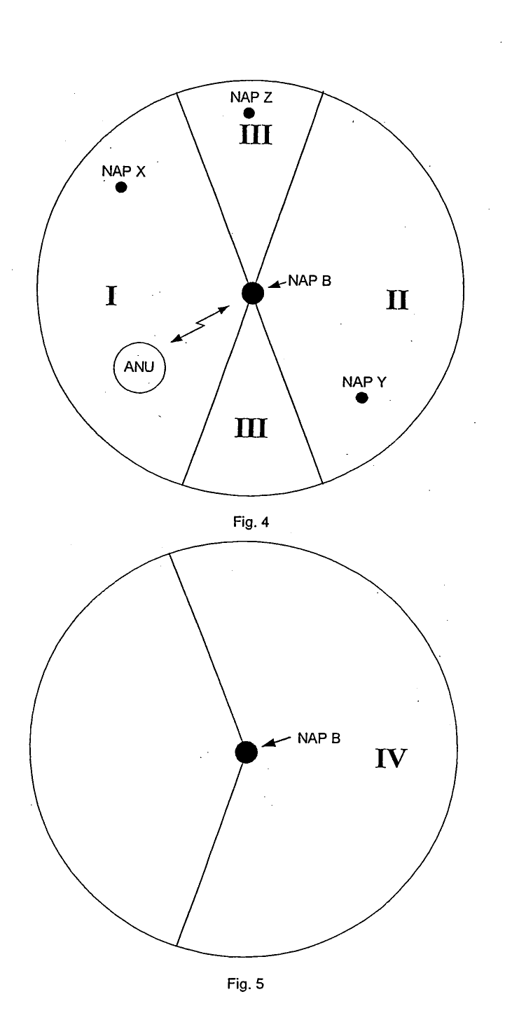

FIG. 4 shows an example of how the measurements, which may be performed as described in connection with FIG. 2 or FIG. 3, may be used for defining a subgroup of network access points. FIG. 4 shows an ANU which communicates with NAPE, it having been decided in the network whether this data communication is to be handed over to another NAP. On the basis of NAPB, the ranges I, II and the ranges III may be defined. It is defined in a table that all NAPXs are in the range I, that all NAPYs are in the range II, and that all NAPZs are in the ranges III. In the example shown in FIG. 4, a measurement in accordance with the principles of FIG. 2 or FIG. 3 will show that ANU is in the range I. According to the invention all NAPXs will only page ANU, while all NAPYs and NAPZs are excluded from paging ANU.

If, however, instead, ANU is close to the plane P in FIG. 2 or the dashed line in FIG. 3, the determination will be relatively unreliable, and if this is the case, two other subgroups III may be defined. The unreliability of the measurement may e.g. be decided on the basis of the degree of consistency between a few repeated measurements. It will be appreciated that on average this method can more than halve the number of NAPs that page ANU.

If it is not desired to evaluate the relative unreliability of the measurements, then, as shown in FIG. 5, the range IV may be selected solely on the basis of a single measurement, which e.g. determines range II, or which may be unreliable. Even with this simple method a considerable reduction in the density of signals is achieved, since NAPX from FIG. 4 is excluded from paging ANU.

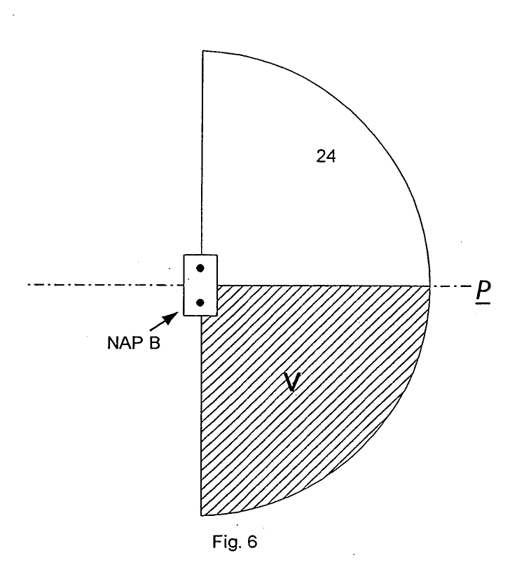

FIG. 6 schematically shows another embodiment in which the principles described in connection with FIGS. 2 and 3 are combined. An antenna radiation range is shown at 24, corresponding to 24 in FIG. 3 for an NAPB, which also has I two antennas and an associated plane P like the one explained in connection with FIG. 2. In a first measurement it may e.g. be decided that ANU is present in the radiation range 24, and in a second measurement it may be decided that ANU is simultaneously present below P in FIG. 6, so that the range V may be defined as a final subgroup. The number of NAPs paging ANU may hereby be reduced to about ¼, and it will be appreciated that the determination of the final subgroup may be supplemented with the principles which have been described in connection with FIG. 4 or FIG. 5.

In a preferred embodiment which is especially expedient in big LANs comprising a large number of NAP s, a group of neighboring NAPs in the vicinity of the current NAP, i.e. the NAP which is in contact with the terminal immediately before initiation of handing over of the data communication to another NAP, is first defined. The identification, number and position of the NAPs in said group are stored in a table, as is the identification of one or more subgroups according to the invention, relative to the current NAP. This can be done according to the principles explained in relation to FIGS. 4-6, and in a preferred embodiment a subgroup is positioned exclusively on one side or on the other side of the current NAP. Having measured on which side of the current NAP ANU is present, it can be defined which NAPs are going to page the ANU and which NAPs are not.

The present invention can be embodied in other specific forms without departing from the spirit or essential characteristics thereof, and the invention is not limited to the specific embodiments described herein. The presently disclosed embodiments are illustrative and not restrictive. The scope is indicated by the appended claims rather than the foregoing description, and all changes within the meaning and range and equivalents thereof are intended to be embraced therein.

1. A method for handing over a terminal preferably an access network user (ANU) from a network access point (NAP) to another NAP, said NAP's being part of an access network (PAN), and wherein a number of NAP's is initiated to page said terminal to be handed over with a view to continuing a data communication, the method comprising:
Identifying a subgroup of said NAPs; and
excluding NAP's not belonging to said subgroup from paging said terminal;
wherein said identifying is based on further communication exclusively between said terminal and the current network access point which is in contact with the terminal immediately before initiation of handing over of the data communication to another network access point.

2. A method according to claim 1, wherein said further communication between the terminal and the current network access point comprises a rough determination of the position of the terminal relative to the current network access point.

3. A method according to claim 1, wherein said further communication between the terminal and the current network access point comprises a rough determination of the direction of movement of the terminal relative to the current network access point.

4. A method according to claim 2, wherein said subgroup also comprises network access points which are positioned in a range in which the rough determination is vitiated by unreliability.

5. A method according to claim 2 wherein said subgroup exclusively comprises network access points which are positioned in a range in which the rough determination is vitiated by relatively great unreliability.

6. A method according to claim 1 wherein said further communication comprises measurement of signal phase difference, measured at the current network access point.

7. A method according to claim 1 wherein said identification is determined on the basis of a specific antenna radiation pattern of the current network access point.

8. A method according to claim 6 wherein two antennas are used at the current access point, each antenna radiating a 180° angle, and that a subgroup is identified to comprise such network access points as are all positioned either at one or the other side of the boundary line between the two angular ranges.

9. A method according to claim 8, wherein said subgroup is identified to comprise such network access points as are all positioned in angular ranges which separate said two angular ranges when said further communication is vitiated by unreliability above a predetermined level.

10. A method according to claim 6 wherein a final subgroup is defined on the basis of the determination of two or more subgroups.

11. A method according to claim 1 wherein each NAP has a number of associated neighbouring NAP's, and that the neighbouring NAP's are defined in a table in an AN server.

12. A method according to claim 11, wherein the table contains information about the spatial positions of the NAP's.

13. A method according to claim 12, wherein the table is dynamically updated.

14. A method according to claim 11 wherein a group of NAP's is defined, comprising a number of NAP's neighbouring said current NAP which is in contact with the terminal immediately before initiation of handing over of the data communication to another NAP, and that said subgroup is i selected from said group of NAP's.

15. A method according to claim 14, wherein said subgroup comprising NAP's is positioned exclusively on one side or exclusively on the other side of the current NAP.

16. A method according to claim 1, wherein the method comprises signaling of Bluetooth signals.
